(19) United States
(12) Patent Application Publication
(10) Pub. No.: US 2006/0203926 A1
(43) Pub. Date: Sep. 14, 2006

(54) Apparatus and method for detecting preambles according to IEEE 802.11A wireless LAN standard

(76) Inventor: Alain Chiodini, Cagnes sur Mer (FR)

Correspondence Address: BAKER & DANIELS LLP;111 E. WAYNE STREET, SUITE 800, FORT WAYNE, IN, 46802, US

(21) Appl. No.: 11/347,943

(22) Filed: Feb. 6, 2006

(30) Foreign Application Priority Data
Feb. 12, 2005 (DE) 10 2005 006 441.8

(51) Int. Cl. H04K 1/10

(52) U.S. Cl. 375/260

(57) ABSTRACT

A novel method and apparatus for short preamble detection within the framework of the 802.11a standard is described. The present invention can be easily implemented in both the radio part (preferred embodiment) and the baseband part (general case) of the receiver to provide short preamble detection. The inventive method and apparatus utilize either a notch comb filter to remove the rake of subcarriers composing the short preamble or a battery of bandpass filters to enhance them. A decision on the presence of the short preamble is made by comparing the magnitude associated to certain qualities of the input and output sequences to a preset threshold. The proposed innovation offers a significant advantage over conventional approaches in terms of gate count and power consumption.

### TECHNICAL FIELD OF THE INVENTION

The invention relates to the field of wireless communication systems and in particular to an apparatus and a method for detecting preambles according to IEEE 802.11a wireless LAN standard.

### BACKGROUND OF THE INVENTION

A 802.11 wireless LAN receiver must detect and recognize incoming signals when listening to the medium. As 802.11 wireless LAN (WLAN) capabilities become a mainstay technology in a host of consumer electronics products, designers must deal with varying power consumption requirements. Since WLAN devices are most of the time in “idle” mode, the power consumed by a WLAN device as it is just “listening” for WLAN traffic is becoming a critical parameter. Thus, designers must pay special attention to preamble detection techniques when building 802.11-enabled architectures.

The acquisition of the initial synchronization, which mainly consists of preamble detection followed by frequency and timing offsets acquisition, is the first indispensable task an 802.11a receiver needs to carry out prior to demodulating data-bearing the OFDM symbols. The OFDM preamble is described in the frequency domain. It consists of a set of tones with frequencies that are multiples of 1.25 MHz and whose phases are aligned to create a waveform with a small peak to average power ratio. This results in a pattern that repeats every 0.8 microseconds in the time domain. Since the 802.11a system is based on the principle of single-shot synchronization, the detection must occur within 4 μs from the starting edge of the packet. This stringent requirement comes from the high data rates featured by 802.11a. It is indeed mandatory to keep the header, which contains the training information and which is split into the short and long preambles, to a minimum to achieve good throughputs.

Basically, there are three families of detection schemes presently used:

A first method is the detection based on the received signal energy (magnitude). This method is perhaps the simplest one used to detect the starting point of incoming signal packets. It is realized in the form of an energy detector which can be implemented either in the analog or digital domain. A threshold value is set and the further digital signal processing circuits are triggered when the in-band energy is above this threshold value. However, if there are a lot of other signals present in the frequency band or if a high sensitivity is desired then the power hungry digital signal processing is invoked too often. The main drawbacks of this scheme are that it consumes a lot of power when the RF environment is particularly noisy and there is no signal discrimination.

A second method provides a detection through cross-correlation. This traditional method uses the known periodic structure of the preamble to detect incoming packets. To allow greater confidence in the detection, several preamble periods can be monitored.

A third method is the detection through double sliding windowing. This method involves the use of two consecutive sliding windows to calculate the received energy and a decision variable is formed which is the ratio of both energies.

As already mentioned, packet detection necessarily precedes synchronization acquisition. This operation basically consists in determining an approximate estimate of the start of the packet and it is fairly obvious that the successful completion of the subsequent synchronization process closely depends on good packet detection performance. By now, existing state of the art detection algorithms suffer from two main drawbacks:

Since present preamble detectors are implemented within the base band processor (BBP), they necessitate the main analog-to-digital converter (ADC) to be always operating which implies a high power consumption. Also, there is a considerable latency introduced by the radio frequency block (RF), which from a practical standpoint prevents the implementation of antenna diversity techniques to enhance the quality of the received signals.

Since the detection process is traditionally performed through cross-correlation followed by comparison to a single threshold, there is a significantly high rate of detection failures due to the wide variety of encountered channels.

### DISCLOSURE OF THE INVENTION

It is object of the invention to provide an apparatus and a reliable method for detecting 802.11a preambles quickly and reducing the power consumption of an associated wireless receiver.

This object is achieved by providing an apparatus and a method for detecting 802.11a preambles as described in the independent claims.

Other features which are considered to be characteristic for the invention are set forth in the dependent claims.

According to the invention, the 802.11a OFDM preamble detector comprises means for converting the analog input signal into a n-bit digital input signal, filtering means for either canceling or enhancing the subcarriers included in the digital input signal and for providing an output signal, evaluating means for determining certain qualities/parameters of the digital input and/or output signals, and decision means for making a decision based on a comparison of the qualities/parameters of the digital input and/or output signals to a preset threshold, and for generating a detection signal if the presence of a 802.11a preamble is detected. The invention provides a low-complexity 802.11a preamble detector using preferably a low-resolution quantized input signal.

The essence of the novel detection scheme described here consists in knocking down or enhancing the set of subcarriers composing the 802.11a short preamble by means of filtering and subsequently processing the resulting signal to issue a decision variable to fulfill a packet detection test. Contrary to cross-correlation based approaches, this approach, which one could call “negative”, lends itself very well to the use of a single threshold for detection.

The preamble detector according to the present invention at least presents three main advantages over existing detector technologies:

For both proposed embodiments, that is the implementation within the RF block and/or the BBP of a WLAN receiver, the complexity of the overall circuit structure is extremely simple which results in significant gate savings.

In the preferred embodiment (RF block implementation), the BBP including the main ADC stays in “idle” mode during medium monitoring and does not need to be activated until successful preamble detection occurs, which results in significant power savings.

In the preferred embodiment, the overall latency is improved because the preamble detector is implemented within the RF block of the receiver closer to the antenna.

### BRIEF DESCRIPTION OF THE DRAWINGS

The construction and method of operation of the invention, together with additional objects and advantages thereof, will be best understood from the following description of specific embodiments when read in connection with the accompanying drawings.

FIG. 1 is a block diagram describing the fundamental preamble detection scheme.

FIG. 2 is a block diagram of a first preferred embodiment of the invention implemented in the radio frequency (RF) block of a WLAN receiver.

FIG. 3 is a block diagram of a second embodiment of the invention implemented in the base band processor (BBP) of a WLAN receiver.

FIG. 4 is a block diagram of a third embodiment of the invention implemented in the base band processor (BBP) of a WLAN receiver.

FIG. 5 is a block diagram of the first embodiment of the preamble detector showing I and Q branches.

### DESCRIPTION OF THE PREFERRED EMBODIMENTS OF THE INVENTION

Although the proposed solutions are meant to be implemented in the RF part of the receiver, the principles can also be extended to the BBP part of the receiver.

The general steps for preamble detection according to the present invention are shown in FIG. 1. In a first step 10, the subcarriers of the OFDM signal constituting the short preamble are canceled. In the next step 11, the resulting signal is processed as to issue a decision variable. In step 12 the decision variable is compared with a preset threshold value to determine, whether an 802.11a preamble is present in the signal or not. The general detection concept of FIG. 1 can be accomplished in several ways described in three embodiments of the invention which have been proposed so far.

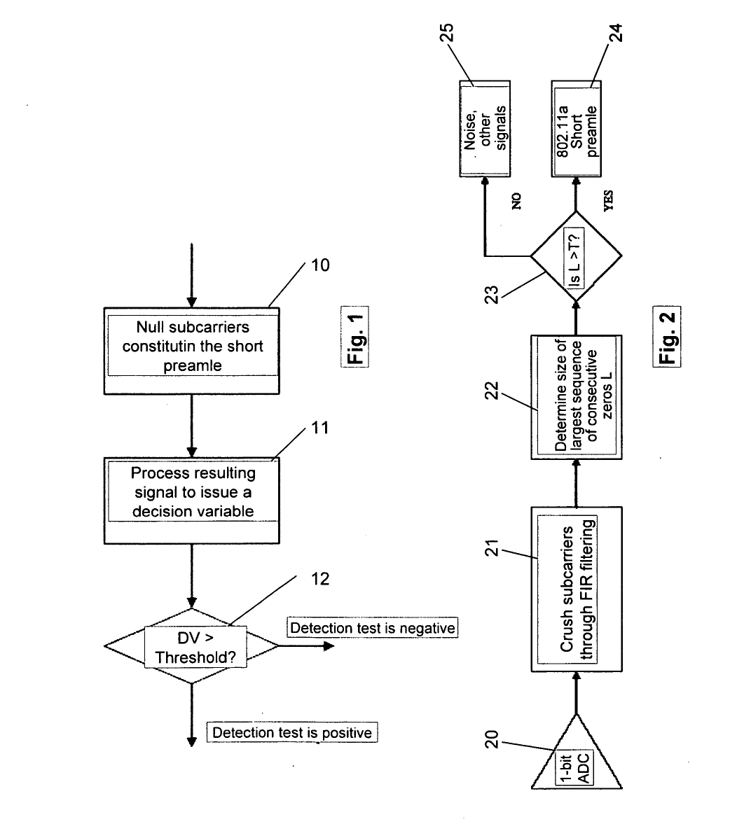

The block diagram of FIG. 2 describes the detection scheme according to a first embodiment. In this preferred embodiment, the detection scheme is implemented upstream of the BBP in the RF block of the receiver. The received analog signal is coupled to an existing auxiliary 1-bit ADC 20 (whose sampling frequency is 40 or 20 MHz) already used for DC offset estimation and compensation. This embodiment takes advantage of the particular structure of the short preamble. The short preamble consists of a well-balanced signal composed of twelve equally spaced subcarriers having equal amplitude and centered on DC which makes it immune to the distortion generated by the 1-bit ADC. A most simple finite impulse response (FIR) filter 21 can be used to cancel the subcarriers, and a digital signal processing (DSP) block 22 determines the largest sequence of consecutive zeros within the filtered signal. The number of consecutive zeros constitutes the decision variable L, which is compared in block 23 against a threshold T to make a decision whether the received signal contains an 802.11a short preamble (block 24) or not (block 25).

Advantageously, a more reliable decision variable can be obtained through branch diversity. In this scenario, both received branches (i.e. I and Q branch) are used rather than a single one and both output signals are added to form the decision variable. Needless to say that this improvement is the preferred one from both the complexity (the gate count is about 150) and energy consumption viewpoints.

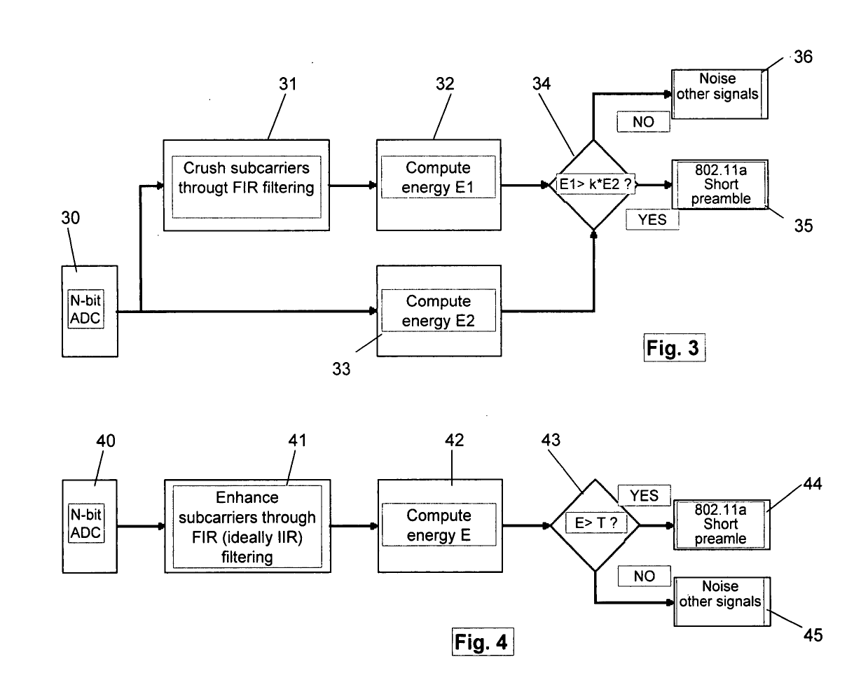

A second embodiment is depicted in FIG. 3. In this general embodiment, the detection scheme is implemented in the BBP part of the receiver. The differences to the first embodiment are as follows:

An N-bit ADC 30 (with n>=8) is used instead of a 1-bit ADC to convert the incoming analog signal to an n-bit digital signal. The ADC 30 used here is preferably the main ADC already implemented the BBP part of the receiver.

The decision variable is no longer based on the determination of the largest sequence of zeros but on the computation of the energies E1, E2 of filtered and unfiltered signals. In FIR block 31 the output signal of the ADC 30 is filtered to cancel the subcarriers, and in the signal processing block 32 the energy E1 of the filtered signal is determined. In a signal processing block 33 the energy 33 of the unfiltered output signal of the ADC 30 is determined. In block 34 the value of E2 is compared to the value of k*E1. If E2>k*E1 a 802.11a short preamble is detected (block 35), otherwise the signal includes no preamble (block 36).

In both cases, i.e., in the first and the second embodiment, the FIR filters 21 and 31 used to cancel the subcarriers are extremely simple and depend on whether a DC offset has to be coped with:
When the RF architecture generates a DC offset that is not fully compensated, one should use the following filter:

$${H}_{40}^{DCO} = ( \begin{matrix}1 & \underbrace{\begin{matrix}2 & … & 2\end{matrix}}_{31 twos} & 1\end{matrix} ) \\ = 1 + 2 {z}^{- 1} + ⋯ + 2 {z}^{- 31} + {z}^{- 32}$$

(If the signal is sampled at 40 MHz)

$${H}_{20}^{DCO} = ( \begin{matrix}1 & \underbrace{\begin{matrix}2 & … & 2\end{matrix}}_{15 twos} & 1\end{matrix} ) \\ = 1 + 2 {z}^{- 1} + ⋯ + 2 {z}^{- 15} + {z}^{- 16}$$

(If the signal is sampled at 20 MHz)
in the other case:

$${H}_{40} = ( \begin{matrix}1 & 0 & - 1 & \underbrace{\begin{matrix}0 & … & 0\end{matrix}}_{29 zeros} & - 1 & 0 & 1\end{matrix} ) \\ = 1 - {z}^{- 2} - {z}^{- 32} + {z}^{- 34}$$

(If the signal is sampled at 40 MHz)

$${H}_{20} = ( \begin{matrix}1 & 0 & - 1 & \underbrace{\begin{matrix}0 & … & 0\end{matrix}}_{13 zeros} & - 1 & 0 & 1\end{matrix} ) \\ = 1 - {z}^{- 2} - {z}^{- 16} + {z}^{- 18}$$

(If the signal is sampled at 20 MHz)

It is to be noted that both, RF and BBP implementations can coexist in the same receiver and the latter can be used preferably to the former under certain adverse conditions.

In a third embodiment of the invention shown in FIG. 4, after the n-bit ADC 40 an infinite impulse response (IIR) filter 41 is used derived from the FIR filters disclosed above to strongly enhance rather than cancel the subcarriers. In block 42 the energy E of the output signal is determined and then compared in block 43 against a threshold T to decide whether a preamble is being received (block 44) or not (block 45). Compared to the second embodiment, this scheme reduces the computational complexity since only one energy value E needs to be computed instead of two values E1, E2 as in the second embodiment.

The characteristic of IIR filter to be used should theoretically be as follows:

$$\begin{matrix}{H}_{40} = \frac{1}{\begin{matrix}1 + {z}^{- 2} + {z}^{- 4} + {z}^{- 6} + {z}^{- 8} + {z}^{- 10} + \\ {z}^{- 12} + {z}^{- 14} + ⋯ + {z}^{- 28} + {z}^{- 30}\end{matrix}} & ( 40 MHz \\ {H}_{20} = \frac{1}{1 + {z}^{- 2} + {z}^{- 4} + {z}^{- 6} + {z}^{- 8} + z {+}^{- 10} + {z}^{- 12} + {z}^{- 14}} & ( 20 MHz )\end{matrix}$$

Now, due to stability problems, we recommend using the following FIR filters, which directly derives from the ones above through Taylor expansion followed by truncation:
H₄₀≅1−z⁻²+z⁻³²+z⁻³⁴
H₂₀≅1−z⁻²+z⁻¹⁶+z⁻¹⁸

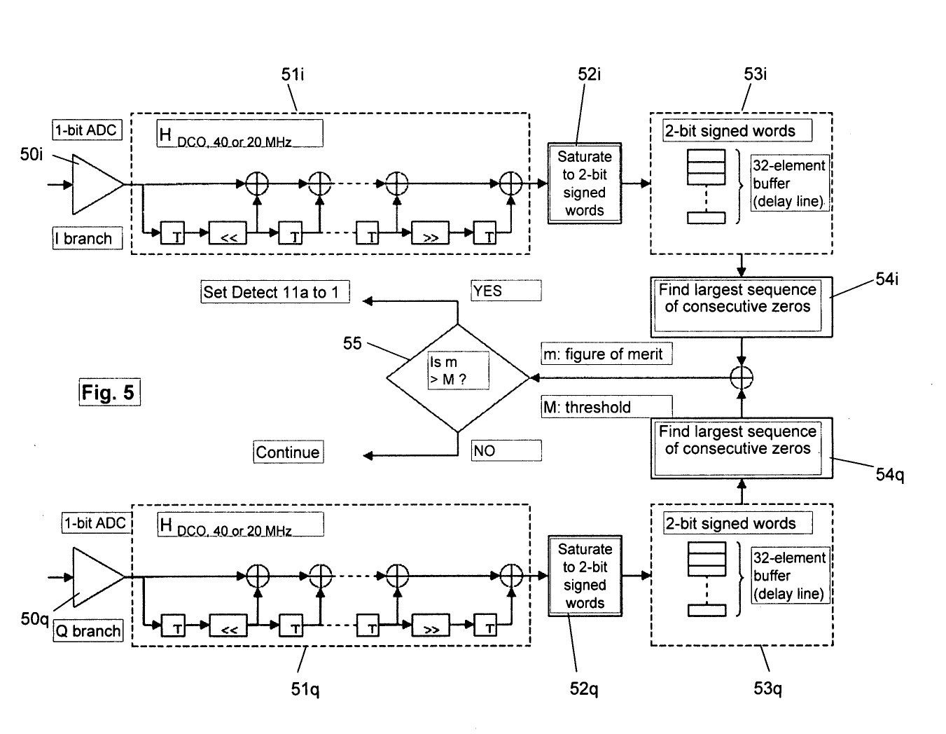

FIG. 5 is a more detailed illustration of the preferred first embodiment of invention showing I and Q signal branches.

Both, the analog I and Q signals are digitized using a pair of 1-bit ADC 50i, 50q. Each of the digital I and Q signals are filtered in a FIR filter block 51i, 51q as to cancel the unwanted subcarriers. In blocks 52i, 52q the filtered I and Q signals are saturated to 2-bit signed words. Each of the 2-bit signed words are input to a 32-element cyclic buffer 53i, 53q (delay line) which stores the input 2-bit signed samples and which 32 storage elements are cyclically overwritten by the actual input samples. Signal processing blocks 54i, 54q are provided as to evaluate the largest sequences of consecutive zeros within the 32 samples (I and Q) stored in each of the buffers 53i, 53q. Both output signals of blocks 54i and 54q are added to form the decision variable m containing the largest sum of consecutive zeros within the I and Q signals. The decision variable m is compared in block 55 against a preset threshold M to make a decision whether the received signal contains a 802.11a short preamble (m>M) or not (m>=M).

1. A OFDM preamble detector for detecting a 802.11a preamble out from a received analog input signal, comprising:
means for converting the analog input signal into a n-bit digital input signal,
filtering means for either canceling or enhancing the subcarriers included in the digital input signal and for providing an output signal,
evaluating means for evaluating certain qualities/parameters of the digital input and/or output signals, and
decision means for making a decision based on a comparison of the qualities/parameters of the digital input and/or output signals to a preset threshold, and for generating a detection signal if the presence of a 802.11a preamble is detected.

2. The preamble detector of claim 1, characterized in that it is implemented in the RF part of a receiver.

3. The preamble detector of claim 1, characterized in that it is implemented in the BBP part of a receiver.

4. The preamble detector of claim 1, characterized in that the means for converting the analog input signal into a digital signal is a comparator/single bit ADC.

5. The preamble detector of claim 1, characterized in that the means for converting the analog input signal into a digital signal is a n-bit ADC.

6. The preamble detector of claim 1, characterized in that the filtering means for canceling the subcarriers has either one of the following filter characteristics:
H₄₀^{DCO}=1+2z⁻¹+ . . . +2z⁻³¹+z⁻³²,
H₂₀^{DCO}=1+2z⁻¹+ . . . +2z⁻¹⁵+z⁻¹⁶, when a DC offset is to be coped with,
Or otherwise,
H₄₀=1−z⁻²+z⁻³²+z⁻³⁴,
H₂₀=1−z⁻²+z⁻¹⁶+z⁻¹⁸.

7. The preamble detector of claim 1, characterized in that the decision means are arranged for making a decision on the presence of a short preamble in the input signal by comparing the maximum number of consecutives zeros found in the output sequence to a preset threshold.

8. The preamble detector of claim 1, characterized in that the filtering means for enhancing the subcarriers has either one of the following filter characteristics:
$${H}_{40} = \frac{1}{\begin{matrix}1 + {z}^{- 2} + {z}^{- 4} + {z}^{- 6} + {z}^{- 8} + \\ {z}^{- 10} + {z}^{- 12} + {z}^{- 14} + ⋯ + {z}^{- 28} + {z}^{- 30}\end{matrix}} , \\ {H}_{20} = \frac{1}{1 + {z}^{- 2} + {z}^{- 4} + {z}^{- 6} + {z}^{- 8} + {z}^{- 10} + {z}^{- 12} + {z}^{- 14}} .$$

9. The preamble detector of claim 1, characterized in that the decision means are arranged for making a decision on the presence of the short preamble by comparing the energy of the input sequence to that of the output sequence multiplied by a preset threshold.

10. The preamble detector of claim 1, characterized in that the magnitude of a complex sample is calculated as follows:
$$z = x + iy , \\ \vert z \vert ≅ max ( \vert x \vert , \vert y \vert ) + \frac{1}{2} min ( \vert x \vert , \vert y \vert ) .$$

11. A method for OFDM preamble detection according to 802.11a standard from a received analog input signal, comprising the steps of:
converting the analog input signal into a n-bit digital input signal,
filtering the digital input signal by either canceling or enhancing the subcarriers included in the digital input signal and providing an output signal,
evaluating certain qualities/parameters of the digital input and/or output signals,
making a decision based on a comparison of the qualities/parameters of the digital input and/or output signals to a preset threshold, and generating a detection signal if the presence of a 802.11a preamble is detected.

12. The method of claim 12, characterized in that the digital input signal is a sequence of 1-bit complex samples (I & Q) delivered by a pair of comparators/single bit ADCs.

13. The method of claim 12, characterized in that the input signal to be processed is a sequence of n-bit complex samples (I & Q) delivered by a pair of n-bit ADCs.

14. The method of claim 12, characterized in that the decision on the presence of a short preamble in the input signal is made by comparing the maximum number of consecutives zeros found in the output sequence to a preset threshold.

15. The method of claim 12, characterized in that the decision on the presence of the short preamble is made by comparing the energy of the input sequence to that of the output sequence multiplied by a preset threshold.

16. The preamble detector of claim 2, characterized in that the means for converting the analog input signal into a digital signal is a comparator/single bit ADC.

17. The preamble detector of claim 3, characterized in that the means for converting the analog input signal into a digital signal is a comparator/single bit ADC.

18. The preamble detector of claim 2, characterized in that the means for converting the analog input signal into a digital signal is a n-bit ADC.

19. The preamble detector of claim 3, characterized in that the means for converting the analog input signal into a digital signal is a n-bit ADC.

20. The preamble detector of claim 2, characterized in that the filtering means for canceling the subcarriers has either one of the following filter characteristics:
H₄₀^{DCO}=1+2z⁻¹+ . . . +2z⁻³¹+z⁻³²,
H₂₀^{DOC}=1+2z⁻¹+ . . . 2z⁻¹⁵+z⁻¹⁶, when a DC offset is to be coped with,
Or otherwise,
H₄₀=1−z⁻²+z⁻³²+z⁻³⁴,
H₂₀=1−z⁻²+z⁻¹⁶z⁻¹⁸.
